(19) United States
(12) Patent Application Publication
(10) Pub. No.: US 2009/0049627 A1
(43) Pub. Date: Feb. 26, 2009

(54) DEVICE FOR USE IN CLEANING ENDOSCOPES

(75) Inventor: Steven Kritzler, New South Wales (AU)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Novapharm Research (Australia) Pty Ltd., Rosebery (AU)

(21) Appl. No.: 11/917,974

(22) PCT Filed: Jun. 29, 2006
(86) PCT No.: PCT/AU2006/000919

§ 371 Date: Jan. 29, 2008

(30) Foreign Application Priority Data
Jun. 30, 2005 (AU) 2005903472

(51) Int. Cl. B08B 9/027

(52) U.S. Cl. 15/104.05

(57) ABSTRACT

Disposable endoscope cleaning device and method, where the device comprises an elongate member, preferably a monofilament and a wiper, or plurality of wipers, formed from a resiliently deformable elastomeric material integrally moulded with the member. The elongate drives the typically disc shaped wiper axially along the lumen axial direction while the wiper remains oriented in a lumen radial plane from adjacent the axial direction to adjacent the lumen wall. The wiper prior has a diameter greater than said lumen internal diameter but is resiliently deformable, preferably not of uniform stiffness in the radial direction, so that it bends in the trailing direction at or near the lumen wall so that a peripheral margin of the wiper contacts the wall in a band extending through 360 degrees of arc. The device allows for cleaning of multiple lumens of differing diameters in an endoscope.

### FIELD OF THE INVENTION

This invention relates to apparatus for use in cleaning endoscopes, and to a method for use of the apparatus. The apparatus and method are particularly useful for cleaning flexible endoscopes having a plurality of lumens of differing diameters, but are not limited to such use.

### BACKGROUND OF THE INVENTION

In recent times the variety of diagnostic examinations being effected by flexible endoscopes has increased and new specialized endoscopes are being developed for various diagnostic and interventional procedures.

There is an increasing appreciation of the large infection control problem presented by these medical devices. In fact, flexible endoscopes represent the most extreme case of difficulty in “reprocessing” (i.e. cleaning and disinfecting) medical instruments. Not only are these instruments very large—potentially over 4 metres long—but they are also extremely complex. They are usually totally opaque and fragile; they may contain fibre optics, lenses, miniature video cameras and the like; and typically have a variety of long hollow lumens with diameters between 1 mm and 5 mm attached to metal spigots leading to complex air and water valves which control negative or positive pressure therein.

It is impossible to reproducibly disinfect or sterilise such devices without first having thoroughly cleaned them. Whilst exacting new international regulatory standards have been introduced to ensure the efficacy of the disinfecting processes used on these complex devices, no regulatory attention, to date, has been focussed on the cleaning steps to be employed prior to the disinfection step.

Cleaning the biopsy and suction channels of these devices presents a particularly difficult challenge. By way of example only, colonoscopes which are one of the most common of the flexible endoscopes, have a biopsy channel over 2 metres long. In one example, the biopsy channel is a flexible, plastic tube of 2.8 mm internal diameter. This channel is used to guide any one of a number of medical devices to a chosen mucosal site. For example biopsy forceps are pushed down the full length of the channel to the site of the mucosa from which the gastroenterologist decides that a biopsy is to be taken. When in place, the forceps cut a sufficient sample from the mucosal wall to enable pathology to be performed. This sample is then dragged back through the length of the biopsy channel for collection. The sampling process may be repeated many times in the course of a single diagnostic procedure. This process leads to the walls of the biopsy channel being coated with biopsy and food particulates, blood, gut mucous, faeces, etc. The suction channel on the other hand has an internal diameter of up to about 4 mm and while the cleaning and cross-infection infection challenges relating to the suction channel are significantly less than for the biopsy channel they are still very significant because gastrointestinal tract contents can be sucked through this lumen. In one example the suction channel is 42% greater in diameter than the biopsy channel, but in other manufacturers endoscopes, the lumens vary in diameter such that the larger may be from 30% to 50% greater in diameter than the smaller diameter and there is no reason why a larger variation could not be encountered.

Failure to adequately clean an endoscope could result in cross infection from one patient to others when the instrument is used subsequently.

Flexible endoscope cleaning guidelines instruct that there are two major process steps are required:-firstly, the biopsy and suction channels must be cleaned with a biopsy lumen brush; and secondly the endoscope must be soaked in a cleaning solution prior to being rinsed with water, dried and disinfected.

The second step utilizes known cleaning compositions comprising highly active, multi-enzyme detergent cleaners which very quickly and efficiently digest human liquid secretions. However, use of these cleaning solutions does not obviate the need to remove particulates from the lumens. That is most commonly accomplished by means of a lumen brush.

Lumen brushes have changed little since the advent of the first flexible endoscopes decades ago. The only recent changes have been the introduction of both autoclavable and disposable models. Reusable lumen brushes have a thin flexible shaft which is typically greater than two meters in length and made from wound stainless steel wire. The brush portion consists of nylon bristles extending radially from the shaft at or near one end. The apparatus has the general appearance of an elongated bottle brush. The manufacture and materials cost of such brushes is undesirably high.

Health care workers involved in the cleaning of endoscopes often complain about the time required to manually brush the lumens, requiring at least 3 cycles of brushing up and down the length of each of the biopsy and suction channels. A total distance of 36 metres of brushing is not atypical. Often, when instruments are required urgently for the next examination there is pressure to curtail this step of the cleaning process, resulting in obvious cross-infection associated risks. Additionally, in the course of each brushing cycle, as the brush tip emerges from the distal end of the endoscope visible contamination is expected to be removed manually by the staff member. If this distal end is not submerged during this process then the bristles flick biological refuse in all directions as they emerge from the lumen leading to other potential cross-infection and Occupational Health and Safety hazards.

Other disadvantages of the currently used brushes include a tendency for the steel brush to abrade parts of the endoscope. Bristles sometimes break off in the lumen which if not noticed may cause injury to a patient. In addition the present inventors have found that since the contamination inside these long lumens is, in the main, liquid or fine particulates the thin flexible bristles simply pass through the liquid contaminant without substantially removing it.

Consequently the efficacy of brushing has been overestimated up to the present.

A variety of devices have been proposed to replace brushes for cleaning elongate bores such as pistol barrels, furnace flues, to oil line pipes and so on. However, to date these devices have generally been inapplicable to the problem of cleaning an endoscope for various reasons. Firstly, the materials of construction of the bores to be cleaned are vastly different from those of endoscopes; secondly, most bores do not generally have other sensitive instruments associated with them, nor do the contaminants have an associated occupational health and safety risk; thirdly, the efficacy of the bore cleaning outcome is generally significantly less critical than in the case of endoscopes; fourthly there is not generally the same demand for disposability as exists with endoscope cleaning devices, and lastly, but by no means least, previous devices other than brushes have been adapted for cleaning a bore of specific diameter whereas in an endoscope the bores to be cleaned differ significantly in diameter one from another, i.e. endoscopes often have a plurality of multidimensional bores.

The present inventors described a pull through apparatus adapted specifically for cleaning an endoscope in PCT/AU/99/00669 (Kritzler). That apparatus comprises a fully circumferential trailing member of smaller diameter than an endoscope bore, which functioned to distribute contaminants uniformly on the bore wall to facilitate enzymatic digestion. A different device is required for each different bore diameter. U.S. Pat. No. 6,889,402 (Galantai), the contents of which are included herein by reference, describes a method of manufacture of a pull though such as described in Kritzler.

Up to the present time, disposable brushes have remained the preferred method for cleaning endoscope lumens. Brushes have been the only single apparatus capable of cleaning multiple lumen bores of substantially differing diameter, for example the suction channel bore, and the biopsy channel bore. Having the capability to clean two bores of an endoscope with a single apparatus halves the cost of disposal compared to use of two devices which can each only be used on a single specified bore diameter. However disposable brushes still suffer from the major disadvantages discussed previously, namely that they are high in manufacture and materials cost, they are at risk of causing damage to an endoscope, pose a significant occupational health risk to users, require multiple passes in use, which is time consuming and costly, and are of questionable efficacy.

Any discussion of the prior art throughout the specification should in no way be considered as an admission that such prior art is widely known or forms part of common general knowledge in the field.

### OBJECT OF THE INVENTION

It is an object of the present invention to provide improved apparatus for use in cleaning an endoscope, and more particularly disposable apparatus suitable for cleaning endoscope lumens of differing diameter, which avoids or ameliorates at least some of the above discussed disadvantages of the prior art. It is an object of preferred embodiments of the invention to provide improved means useful for cleaning both the suction channel lumen and the biopsy channel lumen of a single endoscope (cleaning multiple bores of a single endoscope herein being considered a “single use”). It is a further object of preferred embodiments of the invention to provide a higher cleaning efficacy in a flexible endoscope in one pass than brushes achieve in multiple passes, and to provide endoscope cleaning means which are cheaper, safer and more effective to use than brushes. It is a further object of the invention to provide an improved method for cleaning an endoscope-lumen by use of the apparatus of the invention.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

### BRIEF STATEMENT OF INVENTION

According to a first aspect the invention provides apparatus suitable for cleaning a lumen of an endoscope and intended for disposal after use, the lumen having a first internal diameter, said apparatus comprising an elongate member, a wiper formed from a resiliently deformable elastomeric material integrally moulded with the member, the elongate member being adapted in use for driving the wiper in a lumen axial direction while the wiper remains oriented generally in a lumen radial plane from adjacent the axial direction to adjacent the lumen wall, the wiper prior to deformation in the lumen having a diametric dimension greater than said lumen internal diameter the wiper in use in the lumen being resiliently deformable to bend in the trailing direction at or near the lumen wall so that a peripheral margin of the wiper contacts the wall in a band extending through 360 degrees of arc.

For preference the elongate member is a monofilament, capable of being inserted into and threaded through a lumen of an endoscope to function as a pull through and to pull (or push) the wiper in the axial direction of that lumen. For preference also there is a plurality of wipers, spaced apart from each other in the axial direction. The wiper, or wipers, are desirably of a generally disk like shape and are moulded integrally with the monofilament at or near one end and having the monofilament passing through the disk centres. By saying the wiper remains oriented generally in a lumen radial plane is meant that the wiper extends approximately in that plane and is in a general sense close to a plane perpendicular to the axial direction. No geometric precision is intended, and the wiper faces are not planar in the preferred embodiments. For an endoscope having a maximum channel ID, for example, of 4.0 mm the wipers have a diameter of greater than 4.0 mm, for example, 5.2 mm.

In a preferred embodiment of the invention, in the apparatus according to the first aspect the wiper is stiffer at a radially inner portion adjacent the lumen axis than at a radially outer portion adjacent the lumen wall.

In this particular preferred embodiment, the wiper (or wipers if there are a plurality thereof) are not of uniform stiffness in the radial direction. That is achieved in the preferred embodiment by reducing the thickness in the axial direction as a taper from adjacent the filament towards the outer periphery. Thus the leading face of the wiper prior to deformation in a lumen is very slightly conical or frustroconical. The tapered reduction in thickness facilitates an outer margin of the wiper bending into the trailing direction at or adjacent the wall of, for example, the 4 mm lumen when the filament is pulled through that lumen, and facilitates use of the apparatus in lumens of differing diameter. It also maintains a leading face of the wiper which is substantially perpendicular to the direction of travel over most of the internal diameter of the lumen. The apparatus having a wiper diameter of 5.2 mm is, for example, equally effective in a lumen of internal diameter 2.8 mm, as of 4.0 mm, but in the latter case the blade bends in a trailing direction at a radius closer to the filament and a wider margin deforms to extend in the trailing direction.

It will be understood that a device according to the first aspect can also be used to clean a single bore, for example of an endoscope having only one bore, prior to disposal.

According to a second aspect the invention provides apparatus suitable for cleaning both a first lumen of an endoscope having a first internal diameter, and a second lumen of an endoscope having a second internal diameter wherein the first internal diameter is unequal to the second internal diameter, said apparatus comprising an elongate member, a wiper formed from a resiliently deformable elastomeric material integrally moulded with the member, the elongate member being adapted in use for driving the wiper in a lumen axial direction of the first lumen while the wiper remains oriented generally in a first lumen radial plane from adjacent the axial direction to adjacent the lumen wall, the wiper prior to deformation in the lumen having a diametric dimension greater than said first internal diameter, whereby the wiper in use in the lumen is resiliently deformable to bend in the trailing direction at or near the first lumen wall so that a peripheral margin of the wiper contacts a band of the first lumen wall through 360 degrees of arc; and wherein the elongate member is further adapted for use in driving the wiper in a lumen axial direction of the second lumen while the wiper remains oriented generally in a second lumen radial plane from adjacent the axial direction to adjacent the lumen wall, the wiper prior to deformation in the lumen having a diametric dimension greater than said second internal diameter, whereby the wiper in use in the lumen is resiliently deformable to bend in the trailing direction at or near the second lumen wall so that a peripheral margin of the wiper contacts a band of the second lumen wall through 360 degrees of arc.

By way of example, an embodiment according to the second aspect is intended for single use in cleaning a flexible endoscope having a suction lumen of diameter 2.4 mm and also to clean the biopsy channel lumen of the endoscope having a diameter 4.00 mm. In this example the lumen of the biopsy channel is 43% greater in diameter than the suction channel diameter. The wipers of embodiment for cleaning such an endoscope have a diameter of 5.2 mm and are capable of resilient deformation to wipe both channels prior to disposal.

Desirably the wiper is stiffer in a radially inner portion adjacent the first lumen axis than at a radially outer portion adjacent the first lumen wall. In this case the change in stiffness of the wiper in the radial dimension is chosen in combination with the diameter of the wipers and the flexibility of the wiper material, so that a range of lumen bores can be cleaned such that the largest is up to 50% greater than the smallest. In a preferred embodiment the wiper is made from a thermoplastic elastomer, has a thickness adjacent the filament of about 0.55 mm and is tapered to a thickness of about 0.35 mm at its periphery. This taper results in the stiffness of the wiper decreasing as the radial distance increases from the axis at its centre towards the wiper periphery.

According to a third aspect the invention provides single use apparatus for cleaning a lumen of an endoscope, said apparatus comprising a unitary moulding including an elongate member, a plurality of wipers integral with the member, the elongate member being adapted for driving the wiper in a lumen axial direction while the wipers remains oriented with a leading face extending generally in the lumen radial direction, the wipers being spaced apart in the axial direction and being made from a resiliently deformable elastomeric material, and being resiliently deformable to bend in the trailing direction at or near the lumen wall so that a peripheral margin of the leading wiper contacts the wall in a band extending through 360 degrees of arc, the wipers being stiffer closer to the elongate member than adjacent the lumen wall and the elastomeric material being sufficiently flexible adjacent the lumen wall that when a predetermined quantity of debris builds up against the leading edge of the wiper, that edge deforms sufficiently to allow debris to pass between the wall and the blade to be swept by a downstream wiper

For preference there are between 5 and 9 circular blades, more preferably between 6 and 8 blades, and these are situated at or near one end of the flexible shaft. A loop, bulb or like device to facilitate gripping, and of smaller radial diameter than the narrowest lumen, is desirably provided at or near the end of the shaft remote from the circular blades.

According to a fourth aspect the invention provides a method of cleaning an endoscope comprising the steps of: (1) threading the flexible shaft of apparatus according to the first or second aspect into the suction port of an endoscope; (2) gripping the distal end of the flexible shaft and pulling it until the proximal end emerges from the suction valve; (3) threading said shaft into the biopsy channel of said endoscope; and (4) gripping the distal end of the flexible shaft and pulling it until the proximal end emerges from the other end of the biopsy channel.

According to a fifth aspect the invention provides apparatus suitable for cleaning both the biopsy channel lumen and the suction channel lumen of a flexible endoscope, and for disposal after use, said apparatus comprising at least one wiper, a monofilament adapted to pull or push the wiper in a filament axial direction which in use corresponds with a lumen axial direction, the wiper being integrally moulded with the member and made from a resiliently deformable thermoplastic elastomer, the wiper prior to use being a disk like form centred on the monofilament, and having a diametric dimension greater than the internal diameter of either of said lumens, the wiper being thicker in the axial direction at a radially inner portion adjacent the monofilament than at a radially outer portion adjacent the wiper periphery, whereby the wiper in use when pulled into a lumen resiliently deforms to bend in the trailing direction at or near the lumen wall and contacts the wall in a band extending through 360 degrees of arc.

According to a sixth aspect, the invention provides a method of cleaning an endoscope lumen in need thereof, the lumen having a lumen diameter, the method comprising the step of passing through said lumen an apparatus comprising an elongate shaft and at least one transverse disc member attached to said shaft, the transverse member having a transverse member diameter greater than the lumen diameter, said disc member being resiliently biased and contacting a 360 arc of the lumen, and wherein passing the apparatus through the lumen substantially removes contaminants where present from the lumen wall.

Preferably the lumen is circular in cross section, and the transverse member will also be circular in the corresponding cross section. However, it will be appreciated by those in the art that the lumen and transverse member can be any keyed configuration.

The invention will now be more particularly described, by way of example only, with reference to some specific embodiments.

### BRIEF DESCRIPTION OF THE DRAWINGS

FIG. 1 is a schematic diagram of an endoscope

FIG. 2 is a schematic diagram useful for explaining terminology

FIG. 3 shows a scrap portion of a first embodiment of the invention schematically in an isometric view,

FIG. 4 shows an end elevation of the embodiment of FIG. 3.

FIG. 5 shows a side elevation of the embodiment of FIG. 3

FIG. 6 shows schematically an embodiment of apparatus according to the invention 6(a) outside an endoscope lumen, 6(b) inside a lumen of large diameter, 6(c) inside a lumen of smaller diameter than that of 6(b).

FIG. 7 is a photograph showing (a) a single use brush, (b) a 2.8 mm lumen prior to cleaning with the brush, and (c) the lumen of (b) subsequent to cleaning

FIG. 8 is a photograph showing (a) a PENTAX brand brush, (b) a 2.8 mm lumen prior to cleaning with the brush, and (c) the lumen of (b) subsequent to cleaning

FIG. 9 is a photograph showing (a) a disposable lumen tool having blades not extending through 360 degrees, (b) a 2.8 mm lumen prior to cleaning with the brush, and (c) the lumen of (b) subsequent to cleaning with the tool of (a).

FIG. 10 is a photograph showing (a) a single use brush, (b) a 2.8 mm lumen prior to cleaning with the brush, and (c) the lumen of (b) subsequent to cleaning with the brush of (a)

FIG. 11 is a photograph showing (a) a 2.8 mm lumen prior to cleaning and (b) the lumen of (a) subsequent to cleaning with an embodiment of the invention as described with reference to FIGS. 1-5.

FIG. 12 shows a 4 mm lumen after cleaning with a reusable lumen brush.

FIG. 13 shows a 4 mm lumen after cleaning with a single use lumen brush.

FIG. 14 shows a 4 mm lumen after cleaning with an embodiment of the invention.

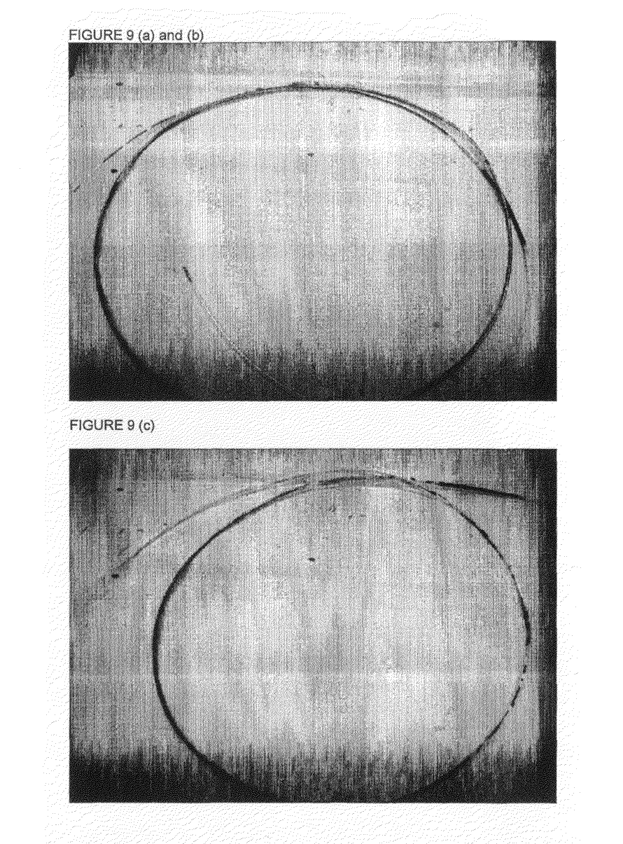

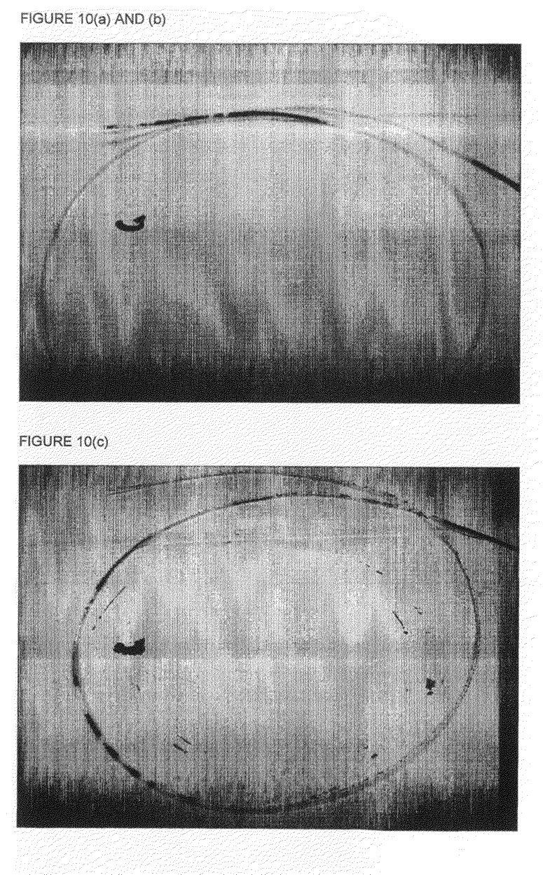

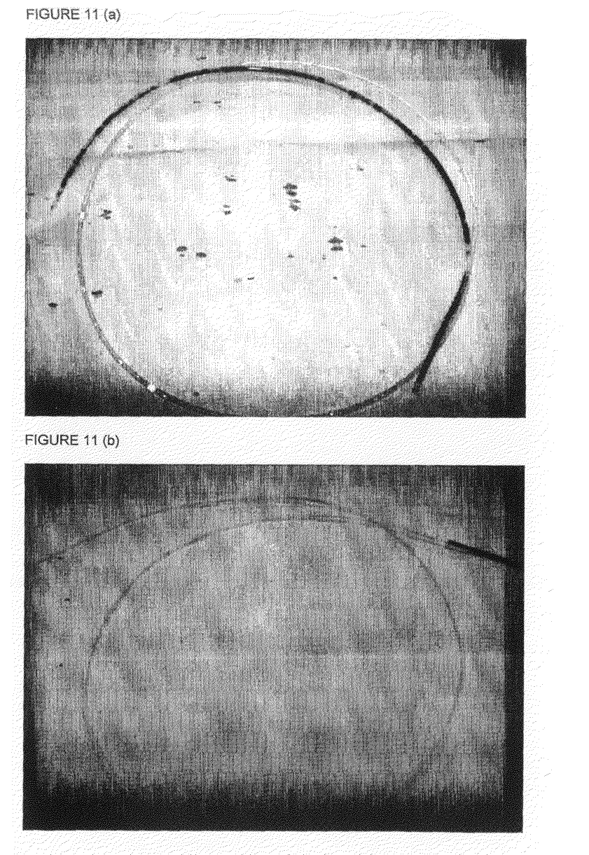

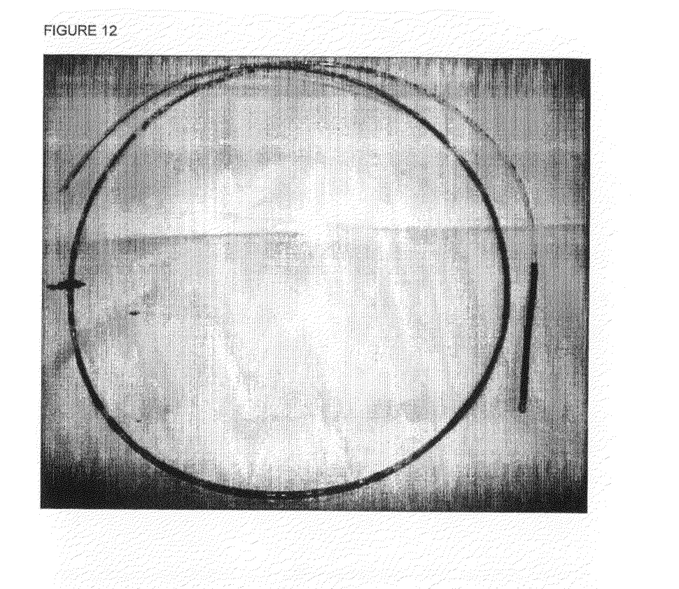

(The device of FIG. 9 was designed for a 2.8 mm lumen and was not capable of cleaning a 4 mm lumen)

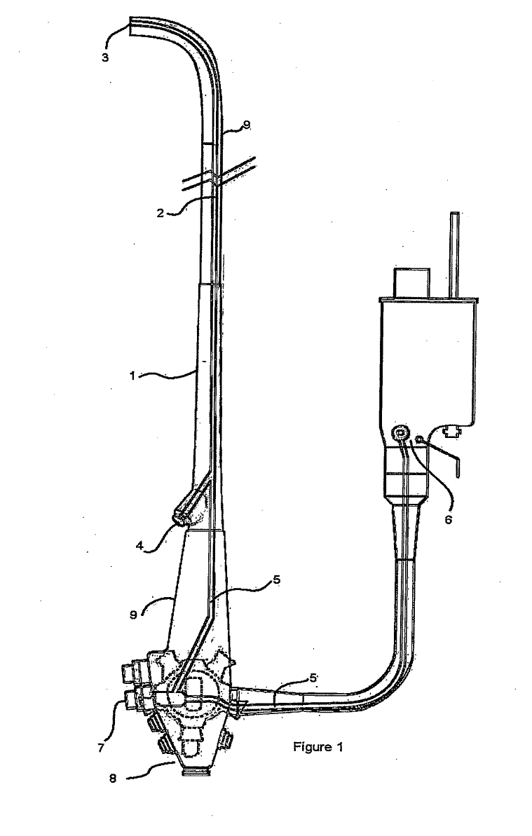

With reference to FIG. 1 there is shown schematically in cross section a flexible endoscope 1. Endoscope 1 has a length of about 2 meters and includes a biopsy lumen 2 which extends from the distal end 3 to a biopsy port 4. A suction lumen 5 communicates from suction port 6 via a suction valve 7 in control head 8 with distal end 3 extending parallel to the biopsy channel within the outer covering 9 in the region between biopsy port 4 and distal end 3. In the described example the biopsy channel has a diameter of 2.8 mm and the suction channel 4.0 mm.

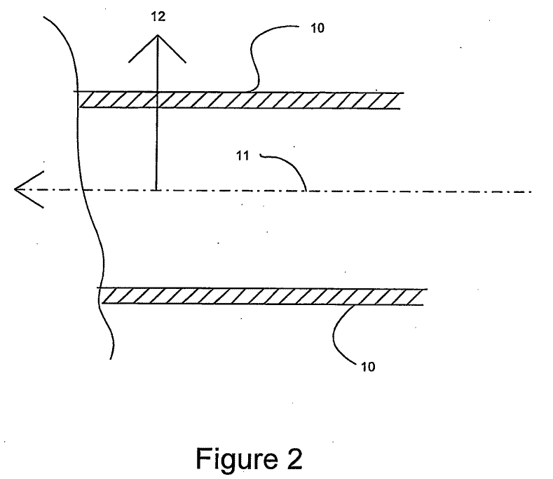

With reference to FIG. 2 there is shown a cylindrical portion of a lumen comprising a lumen wall 10, defining a lumen axial direction 11 which corresponds to the cylinder axis of the lumen. The cylindrical lumen also defines lumen radial directions such as 12 which are perpendicular to axial direction 11. Any two radial directions extending from a point on the axis together define a plane extending in 360 degrees about the point at which the radii intersect the axis and in which radii from that point lie. The plane which intersects the axial direction at right angles is herein referred to as a “lumen radial plane”.

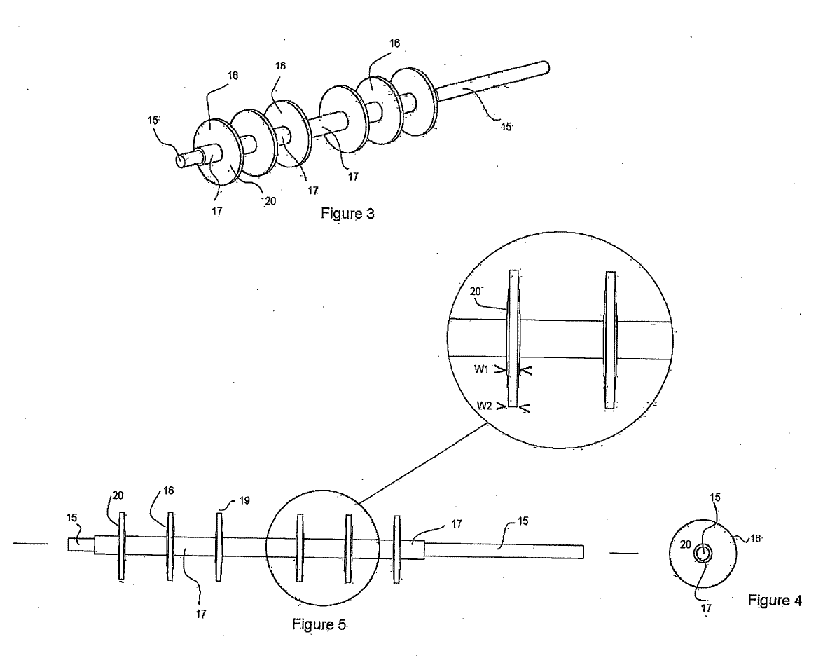

FIG. 3 shows a portion of a first embodiment according to the invention in isomeric view, prior to insertion into a lumen, and is not to scale. The device is a pull through for cleaning both the biopsy channel and the suction channel of a flexible endoscope such as described with reference to FIG. 1. The term pull through” as herein used also includes (where the circumstances allow) a “push through” device. In FIG. 3 there is a monofilament 15 having a plurality of generally disc shaped wipers 16 moulded thereto, the wipers being spaced apart in the filament axial direction, and each wiper 16 disc being centred on the monofilament and extending in a radial direction from the axis of the monofilament, that is to say the wipers extend substantially at right angles to the filament axis. In the embodiment of FIG. 3 there are six wipers 16 Wipers 16 are injection moulded and anchored to the filament by a cylindrical. hub 17 which forms part of the moulded mass and is thermoplastically integrated with the filament during moulding. This arrangement is shown in end elevation in FIG. 4. Monofilament 15 in this example has a diameter of 1 mm, hub 17 has a diameter of about 1.4 mm and wipers 16 have a maximum diameter of 5.2 mm in this embodiment. FIG. 5 shows the portion of FIG. 1 in side elevation. The monofilament in this instance defines a pull through axial direction 18. As shown in FIG. 5, there are six wipers 16. The wipers, while generally disc shaped are however not cylindrical or annular but are narrower in the axial direction at the disc periphery 19 than adjacent hub 17. As shown more clearly in the enlarged inset of FIG. 5, in the present embodiment the wipers taper smoothly from a thickness “W1” adjacent the hub to a thickness “w2” at the radially outermost wiper edge. W1 is about 0.55 mm in the present example, while w2 is 0.35 mm.

In the embodiment illustrated the discs are spaced apart at centres in the axial direction about 2.8 mm apart, but have a somewhat larger spacing between the leading three and the trailing three wipers 16.

The monofilament is desirably sufficiently stiff to enable it to be threaded through an endoscope lumen, and sufficiently long to pass through the lumen and to be gripped at the emerging end. Gripping at the emerging end is desirably aided by moulding a bead, a grip, a loop, or the like at the end remote from the wipers 16. Preferably the monofilament is a polypropylene, is substantially straight and free of any previous spool or coil memory, and is of uniform circular cross section. The monofilament must have a sufficiently high tensile strength for the application and a suitable melting point for bonding with the moulded wipers.

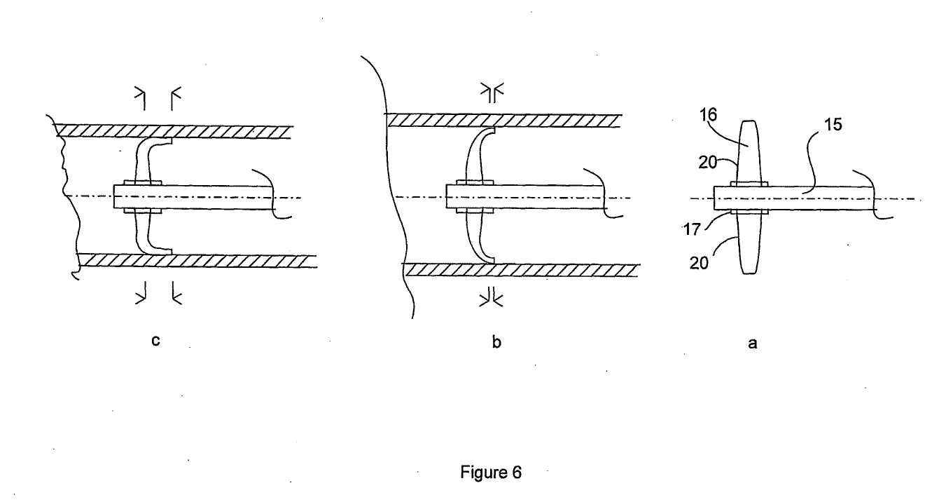

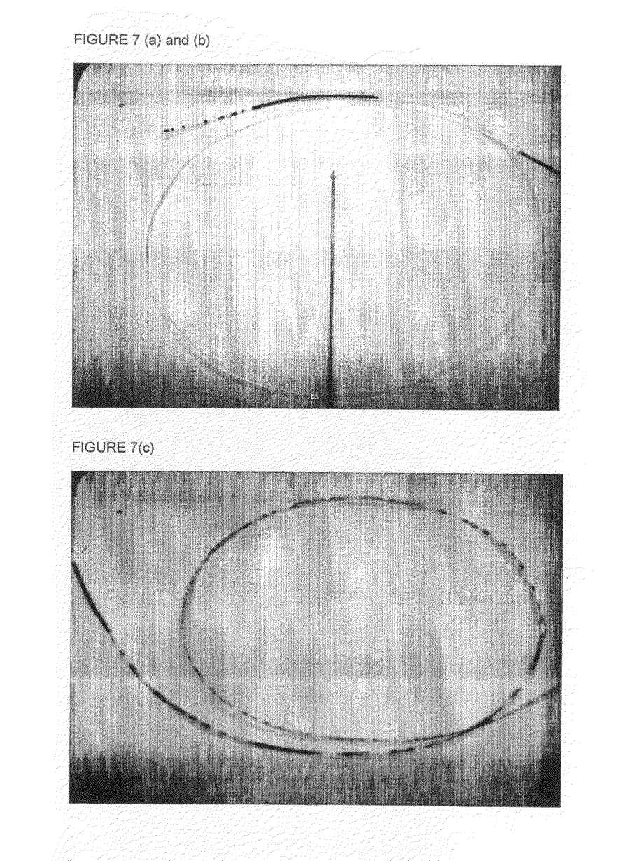

Wipers 16 are made from a resilient deformable material which in the present embodiment is a SANTOPRENE™ elastomer. The elastomer is sufficiently stiff so that when the device is not inserted into a lumen the wipers extend perpendicularly to the axis of the monofilament. However the thermoplastic is deformable so that when the monofilament is threaded into a lumen of large diameter as shown schematically in FIG. 6 the wipers bend in a trailing direction at or near the lumen wall, in preference to near the monofilament axis. The polymer selected must have a suitable melting point to bond with the monofilament or other elongate member during moulding, must have sufficient strength not to break or tear in use, must have sufficient flexibility or deformability to be able to bend into the trailing direction shape required, while having sufficient resilience to extend radially when not confined in a lumen and to engage the wall of the lumen except when pressure on the leading edge exceeds a threshold, but should not be so flexible that it cannot maintain a radially directed leading face for most of the lumen radius.

Santoprene used in the present example has excellent chemical stability, low compression set, good creep resistance, good dimensional stability, and is a recyclable material. It has the following properties:

| Nominal Durometer Hardness: | 64 (ASTMD224); |
|---|---|
| (A Scale, 0.120 in) | |
| Nominal Density: | 0.97 sp gr 23/23° C. (ASTM D792) |
| Tensile set: | 10% (ASTM D412) |
| Tensile stress @100%: | Across flow: 380 psi (ASTM D412) |
| Tensile Str @ Break Elast (73° F.): | Across flow 1010 psi (ASTM D412) |
| Elongation @ Break Elast: | Across flow: 450.0% (ASTM D412) |
| Compression set (73° F., 168 hr): | 23% (ASTM D395) |
| Compression set (212° F., 168 hr): | 32% |

Although this was used for the embodiment herein described other elastomers meeting the discussed requirements could be used.

With reference to FIG. 6 the embodiment of FIG. 3 is shown in axial cross section prior to insertion in the lumen at 6(a). As can be seen the wipers have a greater diameter than the lumen internal diameter, and the leading face extends in a generally radial direction although because of its taper it will slope slightly in the trailing direction towards the peripheral edge. Likewise the trailing face tapers in the leading direction towards the peripheral edge in this example. The apparatus is also shown after insertion into a lumen and after monofilament 15 has been threaded through the lumen and the wipers have been drawn into the lumen bore, see FIG. 6(b). Monofilament 15 is an elongate member which is adapted in use to drive wiper 16 in the lumen axial direction either by pulling it or pushing it. Wiper 16 is a wiper integrally moulded with the elongate member that is to say in this example with the monofilament via moulded hub 17. Wiper 16 remains oriented with its leading face 20 extending in a generally radial direction. That is to say the portion of the upstream face which is radially innermost and close to the lumen axis extends in a generally radial plane. Wiper 16 is made from a resiliently deformable elastomeric material and as shown in 6(a) has a dimension greater than the lumen internal diameter. By virtue that the wiper 16 is thicker in the axial direction at a radially inner portion, that is to say nearer hub 17 than at a radially outer portion, it is stiffer at the radially inner portion and does not bend as easily near the centre line as near the periphery. However the wiper gets thinner as it extends radially outwards, and near the lumen wall where the wiper is thinner than near the hub, it bends toward the trailing direction as the wiper is driven into the lumen. The peripheral portion of blade 16 resiliently engages the inner wall of the lumen over a band extending around a 360 degree arc of the tube wall and remains substantially in that disposition as the wiper is driven through the lumen. Liquid and solid debris in the lumen is pushed forward by the leading wiper or wipers. If the force required to push the debris forward becomes too great the edge of the wiper resiliently deforms, allowing the excess to pass between the leading wiper edge and the lumen wall into the cavity between that wiper and the next downstream. The edge then resiliently reengages the lumen wall over a band of width “W” (FIG. 6b) , or “w” FIG. 6c, in each case the band extending circumferentially through 360 degrees of arc.

As shown in 6(c), if the device is pulled through a lumen of smaller diameter, the wiper bends in a trailing direction at a location close to the lumen wall, that is to say at closer to the hub than in the case shown in FIG. 6(b). However the wiper remains oriented substantially at right angles to the monofilament axis that is with a leading face extending generally in a lumen radial plane, and at the radially inner portion has a leading face extending generally in a lumen radial direction.

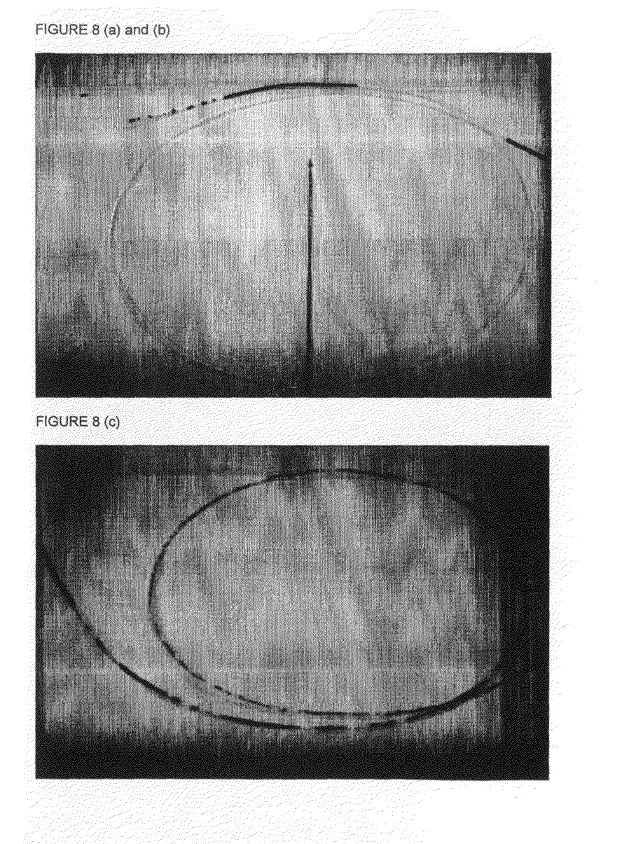

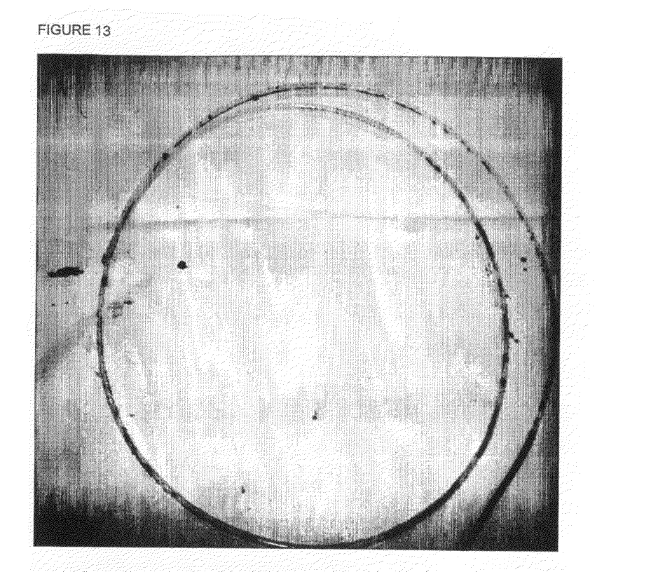

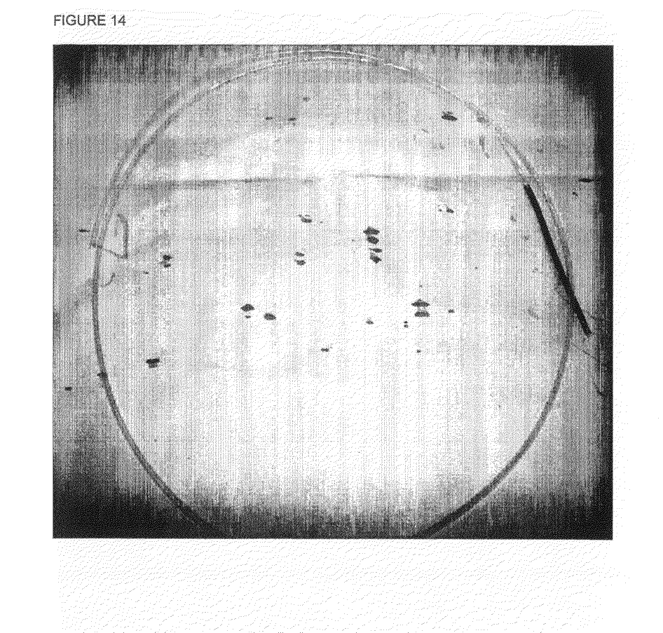

Laboratory tests were conducted using transparent 2.8 mm endoscope lumens which were filled with blood, allowed to drain and then cleaned by means of (1) a reusable lumen brush; (2) a PENTAX brand brush (3) a disposable lumen tool purchased in the UK and having blades projecting outwardly from a pull through cord, each blade having an arcuate edge, the blades being spaced apart, no blade extending 360 degrees, but the blades overlapping so that cleaning occurs around 360 degrees (4) a single use brush and (5) apparatus according to the embodiment of the invention described with reference to FIGS. 1-5. When apparatus 1-4 was used on a single pass, the tube remained visibly contaminated. (see FIGS. 8,9,10,11). Moreover the bristles of the brushes could be seen to move through the blood layer substantially without relocating it, and that also occurred but to a lesser degree with apparatus (3). In the case of apparatus according to the invention the lumen looked substantially clean after one pass.(photo 12). Similar results were obtained using a 4 mm lumen (see FIGS. 13-15). The wiper band contact could be seen to be effective. Moreover it could be seen that when a build up occurred at the leading wiper edge, or a larger piece of debris was encountered, the wiper could deform at the edge to allow the build up or debris to pass between the wiper and the wall so that some material was effectively passed to the space between the wiper and the next trailing wiper. This material was then moved by that next wiper.

Quantitative tests were conducted as follows:

The test for each of the various cleaning devices was conducted on a 2.8 mm Teflon flexible endoscope lumen and also on a 4.0 mm Teflon flexible endoscope lumen.

In each case a clean dry lumen was weighed and a small quantity of blood added by syringe.

After the addition of the blood the lumen was immediately re-weighed and the weight of blood added recorded.

The weight of blood left in the lumen after cleaning was divided by the total amount introduced into the lumen to ascertain the percentage removed. This figure was recorded.

TABLE 1
2.8 mm lumen

| | Weight of Soil in | Weight of Soil in | % |
|---|---|---|---|
| Cleaning Device | Lumen Pre Clean | Lumen Post Clean | Removed |
| Re-Usable Lumen | 2.66 g | 1.88 g | 29.23 |
| Brush | | | |
| Pentax Brush | 3.24 g | 2.81 g | 13.27 |
| UK Disposable Tool | 2.88 g | 0.67 g | 76.74 |
| Single Use Brush | 2.85 g | 0.65 g | 77.19 |
| Pull Through of | 2.66 g | 0.00 g | 100.00 |
| Present Invention | | | |

TABLE 2
4.0 mm lumen.

| | Weight of Soil in | Weight of Soil in | % |
|---|---|---|---|
| Cleaning Device | Lumen Pre Clean | Lumen Post Clean | Removed |
| Re-Usable Lumen | 2.63 g | 2.15 g | 18.25 |
| Brush | | | |
| Pentax Brush | 2.62 g | 2.22 g | 15.28 |
| UK Disposable Tool | 2.59 g | 2.05 g | 20.85 |
| Single Use Brush | 2.52 g | 2.11 g | 16.27 |
| Pull Through of | 2.88 g | 0.00 g | 100.00 |
| Present Invention | | | |

Those skilled in the art could manufacture apparatus according to the invention based on the teaching hereof, and using known injection moulding technology.

It will be understood that the diameter and shape of the elongate member can be varied, as can be the shape of the wipers. Wipers need not be disc shaped and some could for example be annular wipers attached to the hub by three or four radial arms. The wipers could be stiffened adjacent the hub by other means, for example reinforcing or moulded buttresses or by using materials stiffer materials at a radially inner portion and more deformable materials near the periphery. The number of wipers and their location can be varied. Other polymeric elastomers can be used for the moulded wipers in substitution for SANTOPRENE™, for example DOWLEX™, or ENGAGE™. The invention may be embodied in other forms and using other materials without departing from the concepts herein disclosed.

1. An apparatus for cleaning a lumen of an endoscope and intended for disposal after use, the lumen having a first internal diameter, said apparatus comprising an elongate member, a wiper formed from a resiliently deformable elastomeric material integrally moulded with the member, the elongate member being adapted in use for driving the wiper in a lumen axial direction while the wiper remains oriented generally in a lumen radial plane from adjacent the axial direction to adjacent the lumen wall, the wiper prior to deformation in the lumen having a diametric dimension greater than said lumen internal diameter the wiper in use in the lumen being resiliently deformable to bend in the trailing direction at or near the lumen wall so that a peripheral margin of the wiper contacts the wall in a band extending through 360 degrees of arc, and wherein the wiper, or wipers, are of a generally disk like shape and are moulded integrally with the monofilament at or near one end and having the monofilament passing through the disk centres.

2. The apparatus according to claim 1 wherein there is a plurality of wipers, spaced apart from each other in the axial direction.

3. The apparatus according to claim 1 wherein the elongate member is a monofilament, capable of being inserted into and threaded through a lumen of an endoscope to function as a pull through and to pull and/or push the wiper in the axial direction of that lumen.

4. The apparatus according to claim 3 wherein there is a plurality of wipers, spaced apart from each other in the axial direction.

5. The apparatus according to claim 1 wherein the wiper is stiffer at a radially inner portion adjacent the lumen axis than at a radially outer portion adjacent the lumen wall.

6. The apparatus according to claim 3 wherein a wiper is stiffer at a radially inner portion adjacent the lumen axis than at a radially outer portion adjacent the lumen wall.

7. The apparatus according to claim 1 wherein the wiper or wipers are not of uniform stiffness in the radial direction.

8. The apparatus according to claim 7 wherein the wiper or wipers are not of uniform stiffness in the radial direction by reducing the thickness in the axial direction as a taper from adjacent the filament towards the outer periphery.

9. The apparatus according to claim 8 wherein the leading face of the wiper prior to deformation in a lumen is very slightly conical or frustroconical.

10. The apparatus according to claim 8 wherein the tapered reduction in thickness facilitates an outer margin of the wiper bending into the trailing direction at or adjacent the wall of the lumen when the filament is pulled through that lumen, and facilitates use of the apparatus in lumens of differing diameter.

11. The apparatus according to claim 10 wherein the tapered reduction in thickness maintains a leading face of the wiper which is substantially perpendicular to the direction of travel over most of the internal diameter of the lumen.

12. An apparatus for cleaning both a first lumen of an endoscope having a first internal diameter, and a second lumen of an endoscope having a second internal diameter wherein the first internal diameter is unequal to the second internal diameter, said apparatus comprising an elongate member, a wiper formed from a resiliently deformable elastomeric material integrally moulded with the member, the elongate member being adapted in use for driving the wiper in a lumen axial direction of the first lumen while the wiper remains oriented generally in a first lumen radial plane from adjacent the axial direction to adjacent the lumen wall, the wiper prior to deformation in the lumen having a diametric dimension greater than said first internal diameter, whereby the wiper in use in the lumen is resiliently deformable to bend in the trailing direction at or near the first lumen wall so that a peripheral margin of the wiper contacts a band of the first lumen wall through 360 degrees of arc; and wherein the elongate member is further adapted for use in driving the wiper in a lumen axial direction of the second lumen while the wiper remains oriented generally in a second lumen radial plane from adjacent the axial direction to adjacent the lumen wall, the wiper prior to deformation in the lumen having a diametric dimension greater than said second internal diameter, whereby the wiper in use in the lumen is resiliently deformable to bend in the trailing direction at or near the second lumen wall so that a peripheral margin of the wiper contacts a band of the second lumen wall through 360 degrees of arc.

13. The apparatus according to claim 12 wherein the wiper is stiffer in a radially inner portion adjacent the first lumen axis than at a radially outer portion adjacent the first lumen wall.

14. The apparatus according to claim 13 wherein the change in stiffness of the wiper in the radial dimension is chosen in combination with the diameter of the wipers and the flexibility of the wiper material, so that a range of lumen bores can be cleaned such that the largest is up to 50% greater than the smallest.

15. The apparatus according to claim 14 wherein the wiper is made from a thermoplastic elastomer.

16. A single use apparatus for cleaning a lumen of an endoscope, said apparatus comprising a unitary moulding including an elongate member, a plurality of wipers integral with the member, the elongate member being adapted for driving the wiper in a lumen axial direction while the wipers remains oriented with a leading face extending generally in the lumen radial direction, the wipers being spaced apart in the axial direction and being made from a resiliently deformable elastomeric material, and being resiliently deformable to bend in the trailing direction at or near the lumen wall so that a peripheral margin of the leading wiper contacts the wall in a band extending through 360 degrees of arc, the wipers being stiffer closer to the elongate member than adjacent the lumen wall and the elastomeric material being sufficiently flexible adjacent the lumen wall that when a predetermined quantity of debris builds up against the leading edge of the wiper, that edge deforms sufficiently to allow debris to pass between the wall and the blade to be swept by a downstream wiper.

17. The apparatus according to claim 16 wherein there are between 5 and 9 circular blades.

18. The apparatus according to claim 17 wherein there are between 6 and 8 blades situated at or near one end of the flexible shaft.

19. The apparatus according to claim 16 comprising a loop bulb or like device of smaller radial diameter than the narrowest lumen to facilitate gripping at or near the end of the shaft remote from the circular blades.

20 An apparatus suitable for cleaning both the biopsy channel lumen and the suction channel lumen of a flexible endoscope, and for disposal after use, said apparatus comprising at least one wiper, a monofilament adapted to pull or push the wiper in a filament axial direction which in use corresponds with a lumen axial direction, the wiper being integrally moulded with the member and made from a resiliently deformable thermoplastic elastomer, the wiper prior to use being a disk like form centred on the monofilament, and having a diametric dimension greater than the internal diameter of either of said lumens, the wiper being thicker in the axial direction at a radially inner portion adjacent the monofilament than at a radially outer portion adjacent the wiper periphery, whereby the wiper in use when pulled into a lumen resiliently deforms to bend in the trailing direction at or near the lumen wall and contacts the wall in a band extending through 360 degrees of arc.

21. A method of cleaning an endoscope comprising the steps of: (1) threading the flexible shaft of apparatus according to claim 1 into the suction port of an endoscope; (2) gripping the distal end of the flexible shaft and pulling it until the proximal end emerges from the suction valve; (3) threading said shaft into the biopsy channel of said endoscope; and (4) gripping the distal end of the flexible shaft and pulling it until the proximal end emerges from the other end of the biopsy channel.

22. A method of cleaning an endoscope lumen in need thereof, the lumen having a lumen diameter, the method comprising the step of passing through said lumen an apparatus comprising an elongate shaft and at least one transverse disc member attached to said shaft, the transverse member having a transverse member diameter greater than the lumen diameter, said disc member being resiliently biased and contacting a 360 arc of the lumen, and wherein passing the apparatus through the lumen substantially removes contaminants where present from the lumen wall.

23. The method according to claim 22 wherein the lumen is circular in cross section, and the transverse member is circular in the corresponding cross section.

24. The method according to claim 22 wherein the lumen-and transverse member are in a keyed configuration.

25. The apparatus according to claim 9 wherein the tapered reduction in thickness facilitates an outer margin of the wiper bending into the trailing direction at or adjacent the wall of the lumen when the filament is pulled through that lumen, and facilitates use of the apparatus in lumens of differing diameter.

26. The apparatus according to claim 25 wherein the tapered reduction in thickness maintains a leading face of the wiper which is substantially perpendicular to the direction of travel over most of the internal diameter of the lumen.
